(19) United States
(12) Patent Application Publication
(10) Pub. No.: US 2024/0158540 A1
(43) Pub. Date: May 16, 2024

(54) SEAWEED RECYCLING SYSTEM

(71) Applicant: TOYOTA JIDOSHA KABUSHIKI KAISHA, Toyota-shi (JP)

(72) Inventors: Tadayoshi SUMIYA, Toyota-shi (JP); Yuto KAWATA, Ichinomiya-shi (JP); Koseki SUGIYAMA, Sunto-gun (JP); Yasunobu SEKI, Nisshin-shi (JP); Hiroki AWANO, Susono-shi (JP)

(73) Assignee: TOYOTA JIDOSHA KABUSHIKI KAISHA, Toyota-shi (JP)

(21) Appl. No.: 18/380,248

(22) Filed: Oct. 16, 2023

(30) Foreign Application Priority Data
Nov. 14, 2022 (JP) 2022-181922

(51) Int. Cl. C08B 37/00; C02F 1/00; C25B 1/04

(52) U.S. Cl. CPC C08B 37/0084; C02F 1/008; C25B 1/04; C02F 2103/08

(57) ABSTRACT

A seaweed recycling system includes an alginate production apparatus configured to perform processing of washing the seaweed, processing of extracting an aqueous solution containing an alginate component, processing of diluting the extracted aqueous solution, processing of separating the diluted aqueous solution from the seaweed, processing of solidifying and precipitating alginate from the aqueous solution separated from the seaweed, and processing of dehydrating the precipitated alginate, a water purification apparatus configured to perform purification processing of wastewater, a fresh water production apparatus configured to produce fresh water from one of seawater and the purified wastewater, a hydrogen production apparatus configured to produce hydrogen from one of the seawater, the fresh water produced by the fresh water production apparatus, and the purified wastewater; and a control apparatus configured to supply the purified wastewater to one of the fresh water production apparatus, the hydrogen production apparatus, and the alginate production apparatus.

### CROSS REFERENCE TO RELATED APPLICATIONS

This application is based upon and claims the benefit of priority from Japanese patent application No. 2022-181922, filed on Nov. 14, 2022, the disclosure of which is incorporated herein in its entirety by reference.

### BACKGROUND

The present disclosure relates to a seaweed recycling system.

In recent years, there has been a demand for effective use of wastewater generated in processing of recycling seaweed in marine production facilities. For example, Japanese Unexamined Patent Application Publication No. 2005-35967 discloses a system in which natural phenomena are utilized to grow seaweed and the like to capture carbon dioxide from the air, and the seaweed and the like are utilized to produce, separate, and recover methanol, hydrogen, and carbon dioxide.

### SUMMARY

However, Japanese Unexamined Patent Application Publication No. 2005-35967 only discloses a system in which seaweed is utilized to produce methanol, hydrogen, and carbon dioxide, and does not disclose a method for utilizing wastewater generated in the processing of recycling seaweed. In other words, Japanese Unexamined Patent Application Publication No. 2005-35967 has a problem in which wastewater generated in the processing of recycling seaweed cannot be utilized effectively.

The present disclosure has been made in view of the above background, and an object of the present disclosure is to provide a seaweed recycling system capable of effectively utilizing wastewater generated in processing of recycling seaweeds.

A seaweed recycling system according to the present disclosure for performing processing of recycling seaweed includes: an alginate production apparatus configured to perform processing of washing the seaweed obtained from the sea, processing of extracting an aqueous solution containing an alginate component from the washed seaweed, processing of diluting the extracted aqueous solution, processing of separating the diluted aqueous solution from the seaweed, processing of solidifying and precipitating alginate from the aqueous solution separated from the seaweed, and processing of dehydrating the precipitated alginate; a water purification apparatus configured to perform purification processing of wastewater generated in the dehydration processing performed by the alginate production apparatus; a fresh water production apparatus configured to produce fresh water used at least for the washing processing and the dilution processing performed by the alginate production apparatus from at least one of seawater and the wastewater purified by the water purification apparatus; a hydrogen production apparatus configured to produce hydrogen used for a fuel cell from at least one of the seawater, the fresh water produced by the fresh water production apparatus, and the wastewater purified by the water purification apparatus; and a control apparatus configured to supply the wastewater purified by the water purification apparatus to at least one of the fresh water production apparatus, the hydrogen production apparatus, and the alginate production apparatus that uses the wastewater as dilution water for the dilution processing. The seaweed recycling system can effectively utilize wastewater generated in processing of producing alginate from seaweed by purifying the wastewater and supplying it to at least one of a fresh water production apparatus, a hydrogen production apparatus, and an alginate production apparatus. That is, the seaweed recycling system can effectively utilize the wastewater generated in the processing of recycling seaweed.

The present disclosure can provide a seaweed recycling system capable of effectively utilizing wastewater generated in processing of recycling seaweeds.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a block diagram showing a configuration example of a seaweed recycling system according to a first embodiment;

FIG. 2 is a flowchart showing a method for producing alginate by an alginate production apparatus installed in the seaweed recycling system shown in FIG. 1; and

FIG. 3 is a flowchart showing part of an operation of the seaweed recycling system shown in FIG. 1.

### DESCRIPTION OF-EMBODIMENTS

The present disclosure is described below through the embodiment of the disclosure, but the disclosure set forth in the claims is not limited to the following embodiment. Moreover, not all of the configurations described in the embodiment are essential as means to solve the problem. For clarity of explanation, the following descriptions and drawings have been omitted and simplified as appropriate. In each drawing, the same elements are marked with the same signs, and repeated descriptions have been omitted as necessary.

### FIRST EMBODIMENT

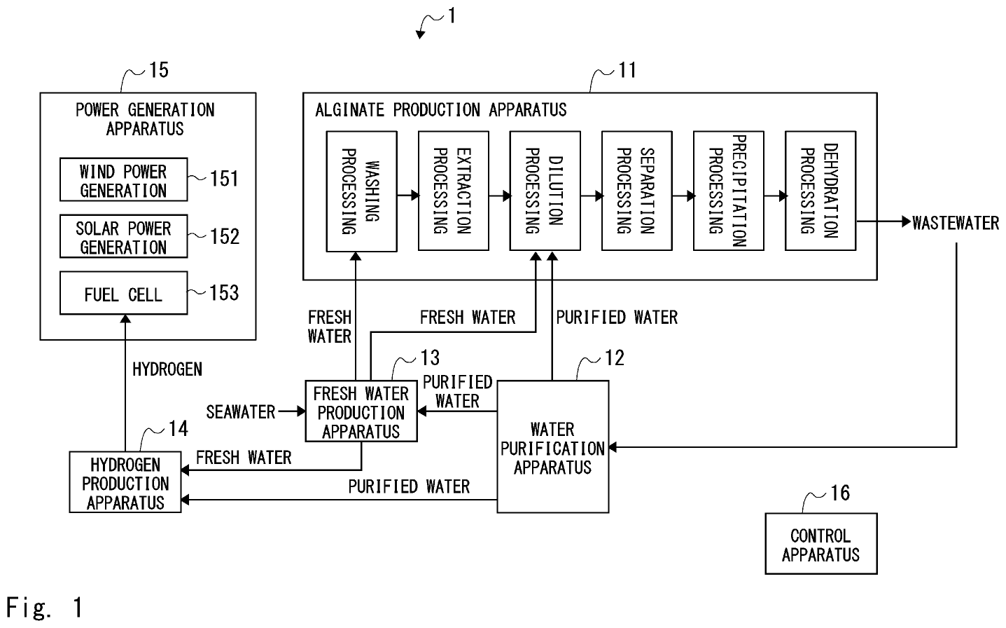

FIG. 1 is a block diagram showing a configuration example of a seaweed recycling system 1 according to a first embodiment. The seaweed recycling system 1 is applied to marine production facilities, etc., constructed at sea where it is difficult to freely bring in resources on land. Here, the seaweed recycling system 1 can effectively utilize wastewater generated in processing of producing alginate from seaweed by purifying the wastewater and supplying it to at least one of a fresh water production apparatus, a hydrogen production apparatus, and an alginate production apparatus. That is, the seaweed recycling system 1 can effectively utilize the wastewater generated in the processing of recycling seaweed. Details are described below.

As shown in FIG. 1, the seaweed recycling system 1 includes an alginate production apparatus 11, a water purification apparatus 12, a fresh water production apparatus 13, a hydrogen production apparatus 14, a power generation apparatus group 15, and a control apparatus 16. The control apparatus 16 is configured to communicate with the alginate production apparatus 11, the water purification apparatus 12, the fresh water production apparatus 13, the hydrogen production apparatus 14, and the power generation apparatus group 15 via a wired or wireless network (not shown).

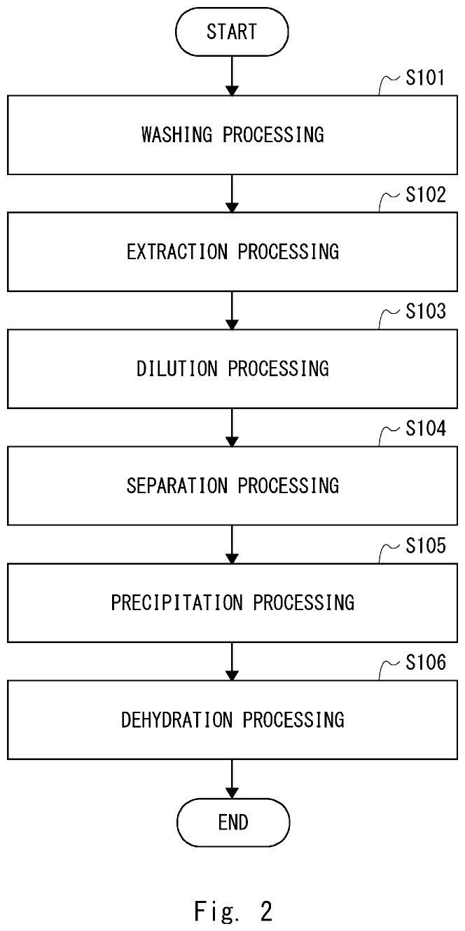

The alginate production apparatus 11 is one of the apparatuses used to perform processing for recycling seaweed and produces alginate from seaweed. The method for producing alginate by the alginate production apparatus 11 is briefly described below with reference to FIG. 2. FIG. 2 is a flowchart showing the method for producing the alginate by the alginate production apparatus 11.

The alginate production apparatus 11 produces the alginate from the seaweed by performing washing processing, extraction processing, dilution processing, separation processing, precipitation processing, and dehydration processing.

First, the alginate production apparatus 11 washes the seaweed obtained from the sea in the washing processing (Step S101).

Next, in the extraction processing, the alginate production apparatus 11 extracts an aqueous solution containing alginate components from the washed seaweed (Step S102). Specifically, the alginate in the seaweed is coupled to multivalent cations such as Ca to form insoluble salts. Therefore, the alginate production apparatus 11 extracts the aqueous solution containing alginate components by causing Na to exchange ions with the multivalent cations such as Ca to form water-soluble sodium alginate.

Next, in the dilution processing, the alginate production apparatus 11 dilutes the extracted aqueous solution (sodium alginate aqueous solution) by adding a large amount of water (Step S103). As a result, the sodium alginate aqueous solution becomes less viscous as it is diluted, making it easier to separate from the seaweed.

Next, in the separation processing, the alginate production apparatus 11 separates the diluted aqueous solution (sodium alginate aqueous solution) from the seaweed (Step S104).

Next, in the precipitation processing, the alginate production apparatus 11 solidifies and precipitates the alginate from the aqueous solution separated from the seaweed (Step S105). Specifically, the alginate production apparatus 11 solidifies and precipitates insoluble alginate by adding acid to the aqueous alginate solution.

Next, in the dehydration processing, the alginate production apparatus 11 dehydrates the precipitated alginate (Step S106). In this way, the alginate production apparatus 11 produces the alginate from the seaweed.

The water purification apparatus 12 purifies the wastewater generated in the dehydration processing, which one of the processing in the alginate production apparatus 11, to produce purified water. Here, a part of the purified water (purified wastewater) generated by the water purification apparatus 12 is used as dilution water for the dilution processing in the alginate production apparatus 11. A part of the purified water may further be used for the washing processing in the alginate production apparatus 11. Thus, the seaweed recycling system 1 can effectively utilize wastewater generated in the processing of producing alginate from the seaweed.

The fresh water production apparatus 13 produces fresh water from at least either seawater or purified water generated by the water purification apparatus 12. Here, the salinity of the purified water produced by the water purification apparatus 12 is lower than that of seawater and closer to that of fresh water. Therefore, the fresh water production apparatus 13 can desalinate the purified water than the seawater more easily. The fresh water produced by the fresh water production apparatus 13 is used for the washing and dilution processing performed by the alginate production apparatus 11 and for producing hydrogen performed by the hydrogen production apparatus 14, which will be described later.

The hydrogen production apparatus 14 produces hydrogen by electrolysis of at least one of seawater, fresh water produced by the fresh water production apparatus 13, and purified water produced by the water purification apparatus 12. The hydrogen produced by the hydrogen production apparatus 14 is used for power generation of a fuel cell 153 described later.

The power generation apparatus group 15 includes a wind power generation apparatus 151, a solar power generation apparatus 152, and a fuel cell 153. The power generation apparatus group 15 only needs to have at least one of the wind power generation apparatus 151, the solar power generation apparatus 152, and the fuel cell 153. The electricity generated in the power generation apparatus group 15 is used to operate a marine production facility to which the seaweed recycling system 1 is applied. The water generated by the power generation of the fuel cell 153 may be used for the washing and dilution processing performed by the alginate production apparatus 11.

The control apparatus 16 provides general control of the seaweed recycling system 1. Here, the control apparatus 16 controls the supply of the purified water generated by the water purification apparatus 12 to the fresh water production apparatus 13, the hydrogen production apparatus 14, and the alginate production apparatus 11. More specifically, the control apparatus 16 controls a percentage of the purified water generated by the water purification apparatus 12 supplied to the fresh water production apparatus 13, the hydrogen production apparatus 14, and the alginate production apparatus 11 in accordance with, for example, a remaining amount of the fresh water, a remaining amount of hydrogen, and an operation state of the alginate production apparatus 11. Thus, the seaweed recycling system 1 can effectively utilize the wastewater generated in the processing of producing alginate from the seaweed.

For example, if the remaining amount of fresh water is less than a predetermined amount, the control apparatus 16 supplies the fresh water production apparatus 13 with a higher percentage of the purified water that is easier to be desalinated than seawater to.

For example, if the remaining amount of fresh water is less than the predetermined amount and the remaining amount of hydrogen is less than a predetermined amount, the control apparatus 16 supplies the production apparatus 14 with a higher percentage of the purified water. It will be cheaper and more efficient than producing fresh water and supplying it to the hydrogen production apparatus 14.

In addition, for example, the control apparatus 16 supplies the alginate production apparatus 11 with a higher percentage of the purified water, because in full operation, the alginate production apparatus 11 will require a large amount of dilution water to be used in the dilution processing of the alginate production apparatus 11.

It should be noted that the control apparatus 16 may control the percentage of the purified water produced by the water purification apparatus 12 supplied to the fresh water production apparatus 13, the hydrogen production apparatus 14, and the alginate production apparatus 11 in accordance with a remaining amount of energy (amount of electricity produced by the power generation apparatus group 15) used to operate the alginate production apparatus 11. In this case, the control apparatus 16 controls, for example, in such a way that the lower the remaining amount of energy, the higher the percentage of purified water supplied to the hydrogen production apparatus 14, whereas the higher the remaining amount of energy, the lower the percentage of purified water supplied to the hydrogen production apparatus 14 and the higher the percentage of purified water supplied to the alginate production apparatus 11 which is expected to be in full operation.

The above method for the control apparatus 16 to control the percentage of purified water to be supplied is only one example and may be changed as appropriate.

### (Operation of Seaweed Recycling System 1)

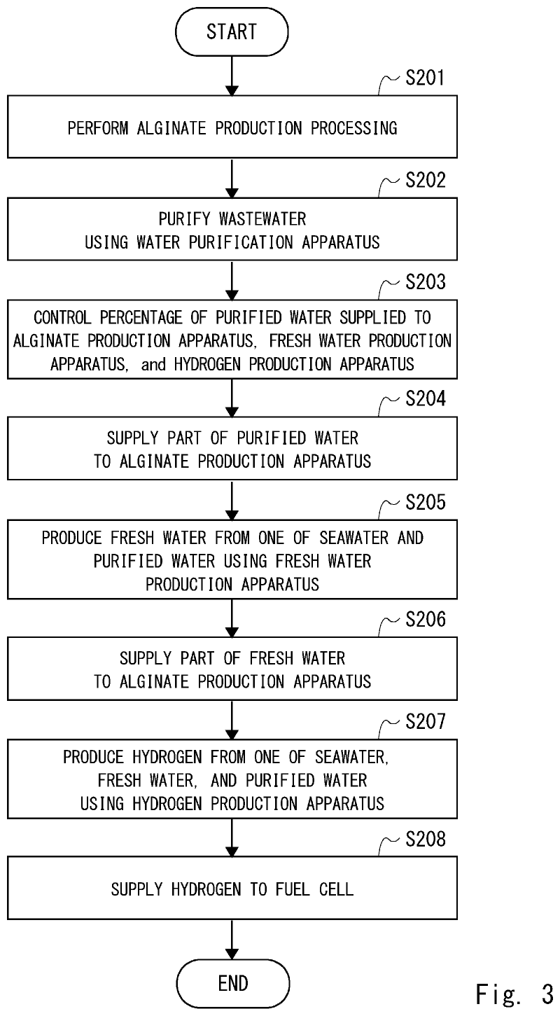

Next, a part of the operation of the seaweed recycling system 1 is explained with reference to FIG. 3. FIG. 3 is a flowchart showing a part of the operation of the seaweed recycling system 1.

First, the seaweed recycling system 1 produces the alginate from the seaweed using the alginate production apparatus 11 (Step S201). During the production of the alginate, the seaweed recycling system 1 performs the purification processing of the wastewater generated in the dehydration processing, which is one of the processing in the alginate production apparatus 11, using the water purification apparatus 12 (Step S202).

Here, the seaweed recycling system 1 controls the supply of the purified water generated by the water purification apparatus 12 to the fresh water production apparatus 13, the hydrogen production apparatus 14, and the alginate production apparatus 11. More specifically, the seaweed recycling system 1 controls the percentage of the purified water generated by the water purification apparatus 12 supplied to the fresh water production apparatus 13, the hydrogen production apparatus 14, and the alginate production apparatus 11 in accordance with, for example, the remaining amount of fresh water, the remaining amount of hydrogen, and the operation state of the alginate production apparatus 11 (Step S203). Thus, the seaweed recycling system 1 can effectively utilize the wastewater generated in the processing of producing alginate from the seaweed.

The seaweed recycling system 1 supplies the alginate production apparatus 11 with the specified supply percentage of the purified water produced by the water purification apparatus 12 (Step S204). The purified water supplied to the alginate production apparatus 11 is used, for example, as the dilution water in the dilution processing, which is one of the processing performed by the alginate production apparatus 11.

The seaweed recycling system 1 then uses the fresh water production apparatus 13 to produce the fresh water from the seawater and the purified water supplied at a specified supply percentage among the purified water produced by the water purification apparatus 12 (Step S205). Here, the salinity of the purified water produced by the water purification apparatus 12 is lower than that of seawater and closer to that of fresh water. Therefore, the fresh water production apparatus 13 can desalinate the purified water more easily than seawater. The seaweed recycling system 1 then supplies part of the fresh water produced by fresh water production apparatus 13 to the alginate production apparatus 11 (Step S206). The fresh water supplied to the alginate production apparatus 11 is used for the washing and dilution processing performed by the alginate production apparatus 11.

Next, the seaweed recycling system 1 uses the hydrogen production apparatus 14 to produce hydrogen by electrolysis of one of seawater, the fresh water produced by the fresh water production apparatus 13, and the purified water produced by the water purification apparatus 12 supplied at a specified supply percentage (Step S207). The seaweed recycling system 1 then supplies the hydrogen produced by the hydrogen production apparatus 14 to the fuel cell 153 (Step S208). The hydrogen produced by the hydrogen production apparatus 14 is used to generate electricity for the fuel cell 153.

Thus, the seaweed recycling system 1 according to this embodiment can effectively utilize the wastewater generated in the processing of producing the alginate from the seaweed by purifying the wastewater and supplying it to at least one of the fresh water production apparatus 13, the hydrogen production apparatus 14, and the alginate production apparatus 11. That is, the seaweed recycling system 1 according to this embodiment can effectively utilize the wastewater generated in the processing of recycling the seaweed.

The present disclosure is not limited to the above embodiment and can be changed as appropriate without departing from the scope. The present disclosure promotes the use of blue carbon (seaweed) and contributes to the Sustainable Development Goals (SDGs) and carbon neutrality.

Moreover, the present disclosure can implement part or all of the processing of the seaweed recycling system 1 by causing a CPU (Central Processing Unit) execute a computer program.

The above program includes instructions (or software codes) that, when loaded into a computer, cause the computer to perform one or more of the functions described in the embodiment. The program may be stored in a non-transitory computer readable medium or a tangible storage medium. By way of example, and not a limitation, non-transitory computer readable media or tangible storage media can include a RAM (Random-Access Memory), ROM (Read-Only Memory), a flash memory, an SSD (Solid-State Drive) or other types of memory technologies, a CD-ROM, a DVD (Digital Versatile Disc), Blu-ray disk or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

The whole or part of the example embodiments disclosed above can be described as, but not limited to, the following supplementary notes.

### (Supplementary Note 1)

A seaweed recycling method performed by a seaweed recycling system for performing processing of recycling seaweed, the seaweed recycling method comprising:
performing, using an alginate production apparatus, processing of washing the seaweed obtained from the sea, processing of extracting an aqueous solution containing an alginate component from the washed seaweed, processing of diluting the extracted aqueous solution, processing of separating the diluted aqueous solution from the seaweed, processing of solidifying and precipitating alginate from the aqueous solution separated from the seaweed, and processing of dehydrating the precipitated alginate;
performing, using a water purification apparatus, purification processing of wastewater generated in the dehydration processing;
producing, using a fresh water production apparatus, fresh water used at least for the washing processing and the dilution processing performed by the alginate production apparatus from at least one of seawater and the wastewater purified by the water purification apparatus;
producing, using a hydrogen production apparatus, hydrogen used for a fuel cell from at least one of the seawater, the fresh water produced by the fresh water production apparatus, and the wastewater purified by the water purification apparatus; and
supplying, using a control apparatus, the wastewater purified by the water purification apparatus to at least one of the fresh water production apparatus, the hydrogen production apparatus, and the alginate production apparatus that uses the wastewater as dilution water for the dilution processing.

### (Supplementary Note 2)

A control program for causing a computer to execute processing for recycling seaweed, the control program comprising:
performing, using an alginate production apparatus, processing of washing the seaweed obtained from the sea, processing of extracting an aqueous solution containing an alginate component from the washed seaweed, processing of diluting the extracted aqueous solution, processing of separating the diluted aqueous solution from the seaweed, processing of solidifying and precipitating alginate from the aqueous solution separated from the seaweed, and processing of dehydrating the precipitated alginate;
performing, using a water purification apparatus, purification processing of wastewater generated in the dehydration processing;
producing, using a fresh water production apparatus, fresh water used at least for the washing processing and the dilution processing performed by the alginate production apparatus from at least one of seawater and the wastewater purified by the water purification apparatus;
producing, using a hydrogen production apparatus, hydrogen used for a fuel cell from at least one of the seawater, the fresh water produced by the fresh water production apparatus, and the wastewater purified by the water purification apparatus; and
supplying, using a control apparatus, the wastewater purified by the water purification apparatus to at least one of the fresh water production apparatus, the hydrogen production apparatus, and the alginate production apparatus that uses the wastewater as dilution water for the dilution processing.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A seaweed recycling system for performing processing of recycling seaweed, the seaweed recycling system comprising:
an alginate production apparatus configured to perform processing of washing the seaweed obtained from the sea, processing of extracting an aqueous solution containing an alginate component from the washed seaweed, processing of diluting the extracted aqueous solution, processing of separating the diluted aqueous solution from the seaweed, processing of solidifying and precipitating alginate from the aqueous solution separated from the seaweed, and processing of dehydrating the precipitated alginate;
a water purification apparatus configured to perform purification processing of wastewater generated in the dehydration processing performed by the alginate production apparatus;
a fresh water production apparatus configured to produce fresh water used at least for the washing processing and the dilution processing performed by the alginate production apparatus from at least one of seawater and the wastewater purified by the water purification apparatus;
a hydrogen production apparatus configured to produce hydrogen used for a fuel cell from at least one of the seawater, the fresh water produced by the fresh water production apparatus, and the wastewater purified by the water purification apparatus; and
a control apparatus configured to supply the wastewater purified by the water purification apparatus to at least one of the fresh water production apparatus, the hydrogen production apparatus, and the alginate production apparatus that uses the wastewater as dilution water for the dilution processing.

2. The seaweed recycling system according to claim 1, wherein the control apparatus controls a percentage of the wastewater purified by the water purification apparatus supplied to the fresh water production apparatus, the hydrogen production apparatus, and the alginate production apparatus in accordance with a remaining amount of fresh water, a remaining amount of hydrogen and an operation state of the alginate production apparatus.

3. The seaweed recycling system according to claim 1, wherein the control apparatus controls a percentage of the wastewater purified by the water purification apparatus supplied to the fresh water production apparatus, the hydrogen production apparatus, and the alginate production apparatus in accordance with a remaining amount of energy used to operate the alginate production apparatus.
